(19) United States
(12) Patent Application Publication
(10) Pub. No.: US 2014/0252160 A1
(43) Pub. Date: Sep. 11, 2014

(54) REVERSE FLOW GAS TURBINE ENGINE REMOVABLE CORE

(71) Applicant: United Technologies Corporation, Hartford, CT (US)

(72) Inventors: Gabriel L. Suciu, Glastonbury, CT (US); Brian D. Merry, Andover, CT (US)

(73) Assignee: United Technologies Corporation, Hartford, CT (US)

(21) Appl. No.: 14/190,150

(22) Filed: Feb. 26, 2014

Related U.S. Application Data
(60) Provisional application No. 61/773,907, filed on Mar. 7, 2013.

(51) Int. Cl. B64D 27/12

(52) U.S. Cl. CPC B64D 27/12
USPC 244/55; 60/797; 29/402.03

(57) ABSTRACT

An engine mounting arrangement includes a propulsor mounted to an aircraft wing, and an engine core aerodynamically connected to the propulsor and positioned rearward of the propulsor.

### CROSS-REFERENCE TO RELATED APPLICATION(S)

This application claims priority from U.S. Provisional Application No. 61/773,907, filed Mar. 7, 2013, for “REVERSE FLOW GAS TURBINE ENGINE REMOVABLE CORE”.

### BACKGROUND

This application relates generally to a gas turbine engine for an aircraft, and more specifically, to a reverse flow gas turbine engine that contains a removable core.

Gas turbine engines often have a two spool core design that includes a low pressure compressor, a high pressure compressor, a high pressure turbine, and a low pressure turbine. The two spool core, that is, the two turbines and compressors, is the gas generator for the engine. The propulsor, on the other hand, is the fan and associated hardware. The propulsor provides the forward movement necessary for aircraft flight. All engines require periodic maintenance. Periodic overhauling is often done on a schedule wherein the hot engine sections (turbines) are overhauled every period, and the cold sections (compressors) are overhauled every other period.

For a typical axial flow gas turbine engine, the engine two-spool core, that is, the gas generator, is in the center of the engine. Removal of the gas generator requires a tear down of half the engine at every overhaul. In existing designs, the propulsor is integrated into the gas generator because one or more shafts extend all the way through the gas generator and are mechanically joined to the propulsor. Currently, small engine auxiliary components like generators and pumps are line replaceable units, meaning that the engine does not need to be removed and separated for replacement of these components. In contrast, to overhaul hot and cold sections, the current process is to remove the entire engine to overhaul the sections. This takes the engine offline for up to ninety days, when all maintenance procedures and engine shipping is accounted for.

### SUMMARY

In one embodiment, an engine mounting arrangement includes a propulsor mounted to an aircraft wing, and an engine core aerodynamically connected to the propulsor and positioned rearward of the propulsor.

In another embodiment, an aircraft has a fuselage, a wing attached to the fuselage, and an engine mounted to the wing. The engine includes an engine mounting arrangement, which includes a propulsor mounted to an aircraft wing, and an engine core aerodynamically connected to the propulsor and positioned rearward of the propulsor.

In a further embodiment, a method of overhauling an engine includes removing an engine core aerodynamically connected to a propulsor, wherein the propulsor is attached to an aircraft wing and remains on the aircraft wing during overhaul of the engine core.

### BRIEF DESCRIPTION OF THE DRAWINGS

FIG. 1 is a schematic view of a reverse core engine.

FIG. 2 is a cross sectional view of an engine mounted to an aircraft wing.

FIG. 3 is a perspective view of an engine core.

### DETAILED DESCRIPTION

Disclosed is a reverse flow engine with a removable core. Thus, the entire gas generator, i.e., low pressure compressor, high pressure compressor, low pressure turbine, and high pressure turbine, is swapped from the engine without need for removal of the propulsor from the aircraft. There is no complete engine drop, and no complex shipping associated with normal axial flow gas turbine engines. In particular, for an under wing installation, the propulsor stays attached to the wing.

In the present design, the fan of the propulsor has an aerodynamic coupling, not a mechanical coupling, with the shaft of the gas generator. With an aerodynamic coupling, the engine core, or gas generator, may be tilted or angled relative to the fan system. This provides a flexible installation as the propulsor may be mounted to the aircraft, and the engine core may be swapped out in a relatively short time.

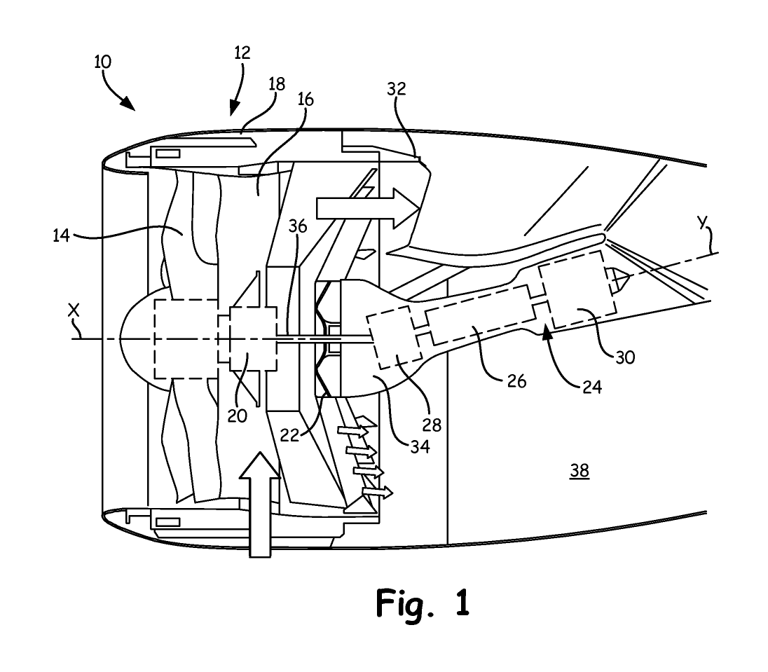

FIG. 1 is a schematic view of a reverse core engine. Engine 10 includes a propulsor 12 at a forward end which is centered for rotation about an axis X. Propulsor 12 includes a fan 14 and a nozzle 16 rearward thereof surrounded by a nacelle 18. Axis X is also a central axis of the fan and the nozzle. Engine 10 may include a gear reduction 20 driven by a power turbine section 22 to drive the fan 14.

A core engine 24 includes combustion section 26 positioned between a turbine section 28 and a compressor section 30. The core engine 24 may also be referred to as the gas generator of the turbine engine. Air from nacelle 18 passes into an inlet duct 32 to be delivered to the compressor 30. The duct 32 is over a limited circumferential extent within nacelle 18. At other circumferential locations within nacelle 18, air flows as bypass air for propulsion. The air is compressed and delivered into combustion section 26, where it mixes with fuel and is ignited. Products of this combustion pass through turbine section 28, which drives compressor section 30. The products of combustion then pass through a transition duct 34 over power turbine section 22, to drive the fan 14 that is connected by thereto by a propulsor shaft 36. Air then exits the power turbine 22 and is exhausted therefrom, such as by having a nozzle that directs the flow aftward upon leaving the power turbine 22. The exhaust from the core engine 24 may be mixed with the bypass flow from the propulsor 12 as it leaves the power turbine 22, creating a single exhaust airflow from engine 10.

The illustrated gas turbine engine is a “reverse flow engine” in that the compressor 30 is positioned further into (forward to aft) the engine than is the turbine 28. That is, the turbine section 28 is closest to the propulsor 12, the combustor section 26 and the compressor section 30 are positioned further away in the downstream or aft direction of the propulsor 12 relative to the turbine section 28.

The engine 10 is positioned such that the fan 12, the gear 20, and the power turbine 22 are positioned centered on the axis X, while the core engine 24, including the compressor section 30, the combustor section 26, and the turbine section 28, is positioned on a non-parallel axis Y. The core engine 24 may be mounted in some manner to the nozzle 16, such as through transition duct 34.

In an engine that is reverse flow, and in particular in one wherein the axes X and Y are not parallel, a relatively long core engine 24 can be achieved without the core engine blocking the exit area 38. However, the overall length of the engine 10 is reduced as the core engine 24 is mounted at an angle with respect to the propulsor 12.

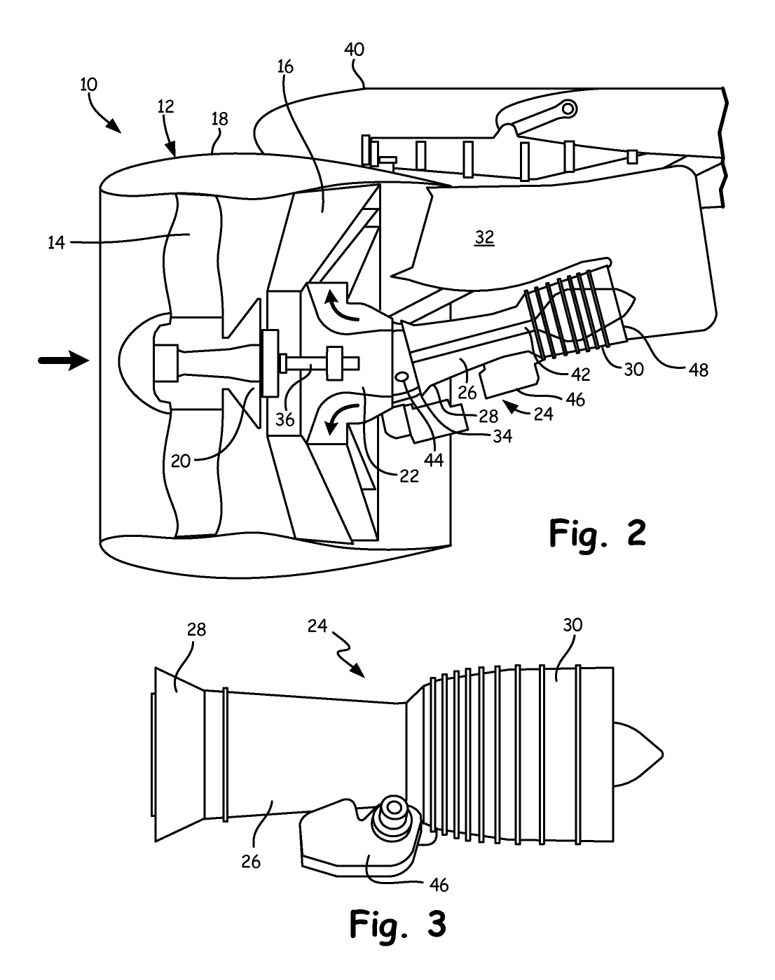

FIG. 2 is a cross sectional view of the engine 10 mounted to an aircraft wing 40. Many of the same elements as shown in FIG. 1 are also illustrated in FIG. 2: the engine 10 with the propulsor 12 having the fan 14 and the nozzle 16 surrounded by the nacelle 18, and the core engine 24 with the combustor section 26, the turbine section 28, and the compressor section 30 aligned along core engine shaft 42. The inlet duct 32 extends from the propulsor 12 to the compressor section 30 of the core engine 24. The transition duct 34 aerodynamically connects the turbine section 28 of the core engine 24 with the power turbine 22.

During normal operation, gases and airflow leaving the turbine section 28 will flow through the transition duct 34 into the power turbine 22, which will turn the propulsor shaft 36. The gear reduction 20 will change the speed of the propulsor shaft 36 as delivered to the fan 14 so that the fan 14 will run at a different speed than that of the power turbine 22. Typically, the gears are sized to slow the speed of the fan 14.

As illustrated, there is no mechanical connection between the propulsor 12 and core engine 24. A portion of propulsor 12 does not rely on mechanical coupling to the core engine 24. Rather, the propulsor 12 is connected to the core engine 24 through an aerodynamic connection. The propulsor 12 is not mechanically driven by the rotation of core engine 24. Operation of the propulsor only relies on receiving the gas generated, i.e., airflow, from the core engine 24 to become operational. The propulsor 12 or nacelle 18 housing the propulsor 12 is mechanically mounted to the wing 40 of the aircraft in such a way to permit rotation of the fan 14.

The core engine 24 is secured to the propulsor 12 through mechanical connections at the aft end 44 of the transition duct 34 and aft end 48 of the inlet duct 32. Both these connections are annular in shape, and the core engine 24 is secured through the use of fasteners. The aforementioned mounting arrangement allows for separate rotation of components with the engine case of the core engine 24 to generate the gaseous exhaust or airflow. In an alternate embodiment, the core engine 24 is secured to the propulsor through a magnetic connection. One or more seals may also be present at the connections. This allows for the removal of the core engine 24, which is illustrated in FIG. 3.

As the core engine 24 is much smaller in size than the entire engine 10, it may be considered a line replaceable component. As such, the core engine 24 may be swapped out for a short inspection or repair much more quickly than the entire engine 10. Also, the core engine 24 may be replaced with another gas separator to get the aircraft back in use. The core engine 24 may have a dedicated auxiliary gear box, controls, and similar accessories 46 that further expedite the core engine removal. The design preferably does not contain any external hardware connections to the propulsor to facilitate quick removal.

In one embodiment, a line replaceable component allows for a quick overhaul of the engine. A method of overhauling an engine consists of removing and replacing only the core, and not the entire engine. The core is sent for service while the rest of the engine remains mounted to the wing. The need for shipping an entire engine is eliminated. This is possible due to the aerodynamic connection between the propulsor and core (versus the typical mechanical connection of the prior art). No shaft removal is done to the propulsor.

A method of overhauling an engine may include removing an engine core aerodynamically connected to a propulsor, wherein the propulsor is attached to an aircraft wing and remains on the aircraft wing during overhaul of the engine core. The unit is inspected, and appropriate repairs are commenced. Upon completion, the engine core is reinstalled. There is no mechanical connection, i.e. a shaft or gearing, between the engine core and the propulsor.

### Discussion of Possible Embodiments

The following are non-exclusive descriptions of possible embodiments of the present invention.

An engine mounting arrangement includes a propulsor mounted to an aircraft wing, and an engine core aerodynamically connected to the propulsor and positioned rearward of the propulsor.

The engine mounting arrangement of the preceding paragraph can optionally include, additionally and/or alternatively, any one or more of the following features, configurations and/or additional components:

wherein the engine core includes a compressor section, a combustor section, and a turbine section, with the turbine section being closer to the propulsor than the compressor section;

wherein the propulsor and engine core are connected by a transition duct;

wherein the propulsor delivers air into the compressor section through a flow inlet duct;

wherein the engine core is attached to the transition duct and flow inlet duct;

wherein the propulsor has a first axis and the engine core has a second axis;

wherein the first axis and second axis are not parallel;

wherein the propulsor is housed in a nacelle;

wherein the propulsor comprises a fan, a power turbine, and a shaft connecting the power turbine to the fan; and/or

a thrust reverser mounted to the nacelle.

In another embodiment, an aircraft has a fuselage, a wing attached to the fuselage, and an engine mounted to the wing. The engine includes an engine mounting arrangement includes a propulsor mounted to an aircraft wing, and an engine core aerodynamically connected to the propulsor and positioned rearward of the propulsor.

The aircraft of the preceding paragraph can optionally include, additionally and/or alternatively, any one or more of the following features, configurations and/or additional components:

wherein the engine core includes a compressor section, a combustor section, and a turbine section, with the turbine section being closer to the propulsor than the compressor section;

wherein the propulsor and engine core are connected by a transition duct;

wherein the propulsor delivers air into the compressor section through a flow inlet duct;

wherein the engine core is attached to the transition duct and flow inlet duct;

wherein the propulsor has a first axis and the engine core has a second axis;

wherein the first axis and second axis are not parallel;

wherein the propulsor is housed in a nacelle;

wherein the propulsor comprises a fan, a power turbine, and a shaft connecting the power turbine to the fan; and/or

a thrust reverser mounted to the nacelle.

In another embodiment, a method of overhauling an engine includes removing an engine core aerodynamically connected to a propulsor, wherein the propulsor is attached to an aircraft wing and remains on the aircraft wing during overhaul of the engine core.

The method of the preceding paragraph can optionally include, additionally and/or alternatively, any one or more of the following features, configurations and/or additional components:

wherein the engine core is a reverse core that includes a compressor section, a combustor section, and a turbine section, with the turbine section being closer to the propulsor than the compressor section.

Although the present invention has been described with reference to preferred embodiments, workers skilled in the art will recognize that changes may be made in form and detail without departing from the spirit and scope of the invention.

1. An engine mounting arrangement comprising:
a propulsor attached to an aircraft wing;
an engine core aerodynamically connected to the propulsor for driving the propulsor with an exhaust flow, and positioned rearward of the propulsor.

2. The engine mounting arrangement of claim 1, wherein the engine core includes a compressor section, a combustor section, and a turbine section, with the turbine section being closer to the propulsor than the compressor section.

3. The engine mounting arrangement of claim 2, wherein the propulsor and engine core are connected by a transition duct.

4. The engine mounting arrangement of claim 3, wherein the propulsor delivers air into the compressor section through a flow inlet duct.

5. The engine mounting arrangement of claim 4, wherein the engine core is attached to the transition duct and flow inlet duct.

6. The engine mounting arrangement of claim 2, wherein the propulsor has a first axis and the engine core has a second axis.

7. The engine mounting arrangement of claim 6, wherein the first axis and second axis are not parallel.

8. The engine mounting arrangement of claim 1, wherein the propulsor is housed in a nacelle.

9. The engine mounting arrangement of claim 8, wherein the propulsor comprises:
a fan;
a power turbine; and
a shaft connecting the power turbine to the fan.

10. An aircraft comprising:
a fuselage;
a wing attached to the fuselage; and
an engine mounted to the wing, the engine including:
a propulsor mounted to an aircraft wing; and
an engine core aerodynamically connected to the propulsor.

11. The aircraft of claim 10, wherein the engine core includes a compressor section, a combustor section, and a turbine section, with the turbine section being closer to the propulsor than the compressor section.

12. The aircraft of claim 11, wherein the propulsor and engine core are connected by a transition duct.

13. The aircraft of claim 12, wherein the propulsor delivers air into the compressor section through a flow inlet duct.

14. The aircraft of claim 15, wherein the engine core is attached to the transition duct and flow inlet duct.

15. The aircraft of claim 16, wherein the propulsor has a first axis and the engine core has a second axis.

16. The aircraft of claim 17, wherein the first axis and second axis are not parallel.

17. The aircraft of claim 10, wherein the propulsor is housed in a nacelle.

18. The aircraft of claim 17, wherein the propulsor comprises:
a fan;
a power turbine; and
a shaft connecting the power turbine to the fan.

19. A method of overhauling an engine, the method comprising:
removing an engine core aerodynamically connected to a propulsor, wherein the propulsor is attached to an aircraft wing and remains on the aircraft wing during overhaul of the engine core.

20. The method of claim 19 wherein the engine core is a reverse core that includes a compressor section, a combustor section, and a turbine section, with the turbine section being closer to the propulsor than the compressor section.
